(19) United States
(12) Patent Application Publication
(10) Pub. No.: US 2006/0212301 A1
(43) Pub. Date: Sep. 21, 2006

(54) Entity property management

(75) Inventor: Lars Dragheim Olsen, Karlslunde (DK)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/083,917

(22) Filed: Mar. 18, 2005

(51) Int. Cl. G06Q 99/00

(52) U.S. Cl. 705/1

(57) ABSTRACT

Methods and data structures for the management of a data entity during an entity lifecycle. An entity having a property and at least one operation having a property characteristic are defined. The operation may be performed on the property according to the characteristic. An entity lifecycle having the at least one operation is created, and a user interface is rendered according to the operation.

### FIELD OF THE INVENTION

The present invention relates generally to data entities and, more particularly, to operation-based interaction with an entity and definition of an entity lifecycle.

### BACKGROUND OF THE INVENTION

A data entity that is used in a particular computing context, such as business process automation, may have what is known as a “lifecycle.” In a typical lifecycle, an entity is first created, and properties of the entity may editable at certain times and may be read-only at other times. Finally, the entity may be deleted once a certain event has occurred.

As a business process automation example, a sales order may be implemented as an entity having a lifecycle defined by the process by which a sales order is created and fulfilled. An example sales order entity may be created when a customer decides to purchase an item, and may contain properties corresponding to the customer's name, order, address, account information, order status and so forth. Once the order is completed, certain of the properties may become read-only to prevent data loss. For example, the customer's personal and account information may become read-only, but the order information may be editable if the system provides for customer changes to the order. In addition, a property corresponding to a reason for order cancellation may be read-only until such time as the customer cancels the order, and at that point may become editable to permit a description to be entered. Finally, once the order is completed, the entity may be deleted or modified for long-term storage. Thus, this sales order entity has a lifecycle beginning at the time a customer places an order, proceeding through the ordering and fulfillment processes, and terminating at the completion of the sales order.

Unfortunately, traditional developer tools are limited in the manner by which an entity lifecycle, such as the example lifecycle described above, may be implemented. For example, some traditional tools enable a developer to specify whether a property is read-only or editable. However, a conventional tool typically only permits a developer to specify such a property characteristic once for the entity lifecycle, after which the property characteristic is stored in a database and cannot be changed by default. For example, a property designated as editable will always be editable throughout its entity's lifecycle. Likewise, a read-only property may be edited when the entity is created, but is then read-only for the duration of the entity's lifecycle. More advanced entity property management, such as making a property editable for a given portion of an entity lifecycle, or if a specified event occurs such as the order cancellation discussed above, is not typically available.

Two conventional solutions to the shortcomings of traditional developer tools involve writing code in the user interface (UI) or writing code outside of the UI to validate a property's status. Both of these conventional solutions have shortcomings of their own.

The convention solution of writing code in the UI is typically limited to a data entry form in which the code is operating. For example, such form-based code may disable certain editable entity properties in the entity's data entry form to prevent the properties from being modified until later in the entity's lifecycle. In effect, the code allows such editable properties to act temporarily as read-only by structuring the form to not allow modifications to the properties. Later in the entity's lifecycle, the form may permit access to the properties. However, more than one form may be used to interact with an entity, and therefore the logic of the code needs to be duplicated for each form. Thus, this solution is unnecessarily complicated because of the duplicated effort complexity of the code required to manage the entity's lifecycle.

The conventional solution of writing code outside of the UI also has shortcomings. Such code, rather than being form-based as in the conventional solution discussed above, is entity-based. For example, a form having an entity's properties exposed as editable may be presented to a user. The conventional, entity-based code may entail validation logic that is written onto the entity to verify whether a particular property is editable. If the property is not editable, an error message having an explanation that the property is not editable typically is generated. Thus, this solution does not need to duplicate code for each form used in connection with the entity because the code is associated with the entity itself. However, a significant shortcoming of this solution is a poor user experience: a user does not know if a particular property is editable until after attempting to edit the property. Thus, a property may be presented as editable in a form, the user attempts to edit the property and then the user receives an error message that the property is in fact read-only. Such occurrences typically lead to user frustration because of the inefficient nature of such a process.

In addition, both such conventional solutions require the code that is being used to be fairly complex, because the code needs to maintain the state of each property (e.g., editable, read-only, etc.) at each point in the lifecycle. Thus, the code that is conventionally used in such solutions—whether inside or outside of the UI—requires specific instructions to manage the entity's lifecycle.

Accordingly, there is a need for a mechanism by which an entity property may be managed in a form-independent manner, while tailoring the presentation of property options to a user. The present invention satisfies this need.

### SUMMARY OF THE INVENTION

In view of the foregoing shortcomings and drawbacks, the invention is directed to the management of a data entity during an entity lifecycle. An entity having a property and at least one operation having a property characteristic are defined. The operation may be performed on the property according to the characteristic. An entity lifecycle having the at least one operation is created, and a user interface is rendered according to the operation.

According to a feature of the invention, a data entity having a first and second property is defined. An operation specifying whether the first and second properties are editable is also defined. An entity lifecycle having the at least one operation is created, and a user interface is rendered according to the at least one operation.

According to another feature of the invention, a computer-readable medium has data structure having a first, second and third data field. The first data field contains a data entity operation for interacting with a data entity property. The second data field contains data identifying the data entity property. The third data field contains data representing a characteristic of the data entity property that indicates a type of interaction the data entity operation may have with the identified data entity property.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings example constructions of the invention; however, the invention is not limited to the specific methods and instrumentalities disclosed. In the drawings:

FIG. 1 is a diagram illustrating an example computing environment in which aspects of the invention may be implemented;

FIG. 2 is a diagram illustrating an example computer network in which aspects of the invention may be incorporated;

FIG. 3 is a flowchart illustrating an example method of managing an entity lifecycle according to an embodiment of the invention;

FIG. 4 is a diagram illustrating an example lifecycle in which aspects of the invention may be implemented;

FIGS. 5A-C are diagrams illustrating example operations according to one embodiment of the invention; and

FIG. 6 is a diagram illustrating an example lifecycle according to one embodiment of the invention.

### DETAILED DESCRIPTION OF ILLUSTRATIVE EMBODIMENTS

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Example Computing Environment

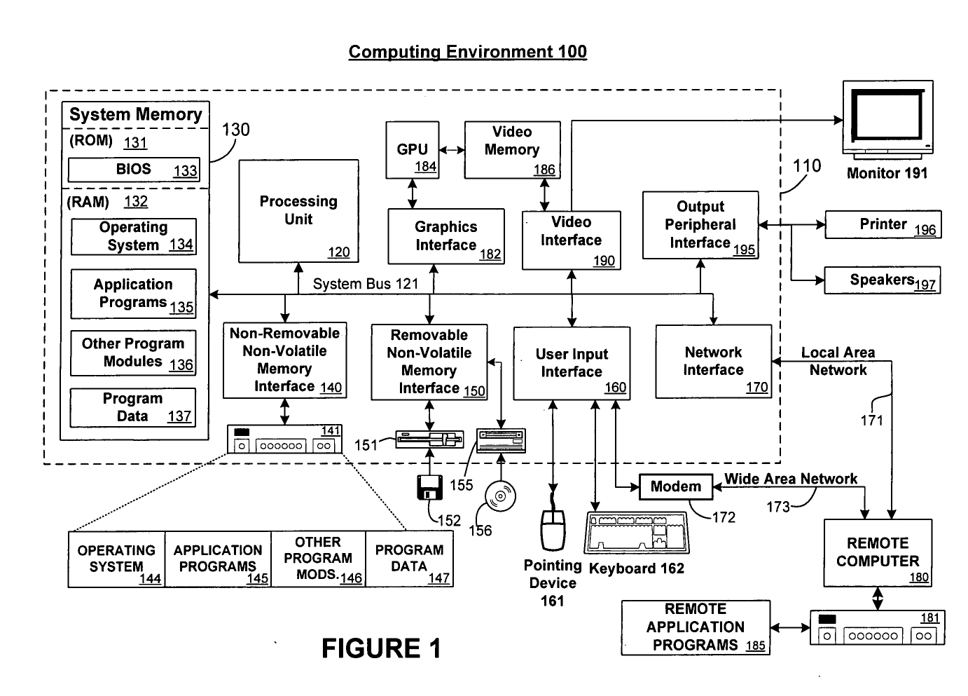

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the example operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. Typically the functionality of the program modules may be combined or distributed as desired in various embodiments. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read-only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are examplary and other means of establishing a communications link between the computers may be used.

Example Distributed Computing Frameworks or Architectures

Various distributed computing frameworks have been and are being developed in light of the convergence of personal computing and the Internet. Individuals and business users alike are provided with a seamlessly interoperable and web-enabled interface for applications and computing devices, making computing activities increasingly web browser or network-oriented.

For example, MICROSOFT®'s .NET platform includes servers, building-block services, such as web-based data storage, and downloadable device software. Generally speaking, the .NET platform provides (1) the ability to make the entire range of computing devices work together and to have user information automatically updated and synchronized on all of them, (2) increased interactive capability for web sites, enabled by greater use of XML rather than HTML, (3) online services that feature customized access and delivery of products and services to the user from a central starting point for the management of various applications, such as e-mail, for example, or software, such as Office NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors, and (7) many other cross-platform integration features as well.

While example embodiments herein are described in connection with software residing on a computing device, one or more portions of the invention may also be implemented via an operating system, API, or middleware software between a coprocessor and requesting object, such that services may be performed by, supported in, or accessed via all of NET's languages and services, and in other distributed computing frameworks as well.

Network Environment

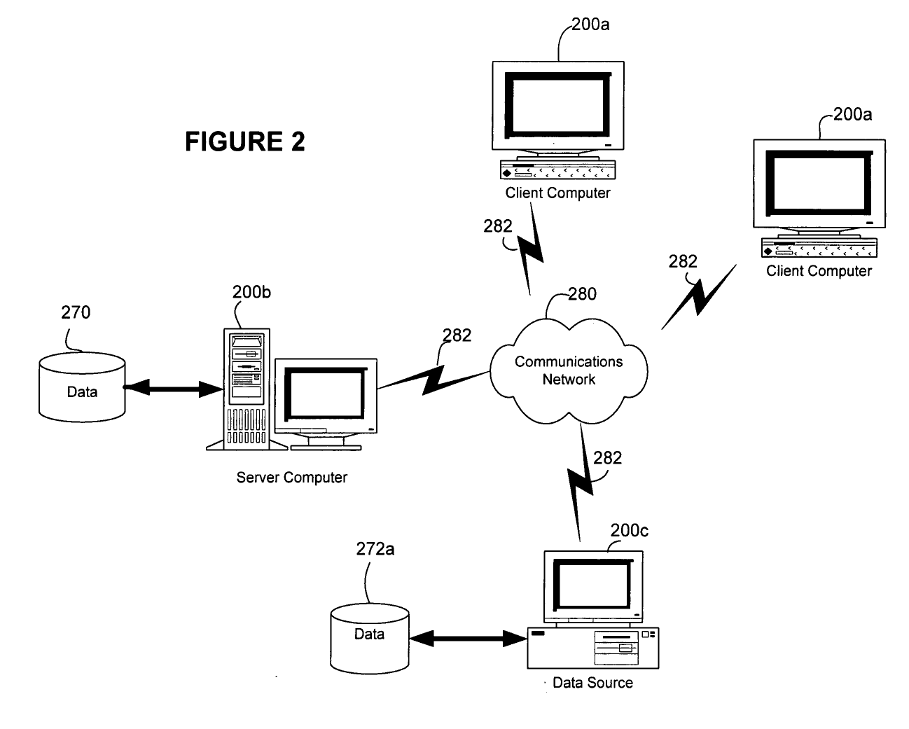

FIG. 2 illustrates an example network environment in which the present invention may be employed. Of course, actual network and database environments may be arranged in a variety of configurations; however, the example environment shown here provides a framework for understanding the type of environment in which an embodiment may operate.

The example network may include one or more client computers 200a, a server computer 200b, data source computers 200c, and/or databases 270, 272a, and 272b. The client computers 200a and the data source computers 200c may be in electronic communication with the server computer 200b by way of the communications network 280 (e.g., an Intranet). The client computers 200a and data source computers 200c may be connected to the communications network by way of communications interfaces 282. The communications interfaces 282 can be any type of communications interfaces such as Ethernet connections, modem connections, wireless connections and so on.

The server computer 200b may provide management of the database 270 by way of database server system software or the like. As such, server 200b may act as a storehouse of data from a variety of data sources and provides that data to a variety of data consumers.

In the example network environment of FIG. 2, a data source may be provided by data source computer 200c. Data source computer 200c may communicate data to server computer 200b via communications network 280, which may be a LAN, WAN, Intranet, Internet, or the like. Data source computer 200c may store data locally in database 272a, which may be database server or the like. The data provided by data source 200c can be combined and stored in a large database such as a data warehouse maintained by server 200b.

Client computers 200a that desire to use the data stored by server computer 200b can access the database 270 via communications network 280. Client computers 200a access the data by way of, for example, a form, a query, etc. It will be appreciated that any configuration of computers is equally compatible with an embodiment of the present invention.

Example Embodiments

As noted above, embodiments of the invention satisfy a need for a mechanism by which an entity property may be managed in a form- and entity-independent manner, while tailoring the presentation of property options to a user. In one such embodiment, for example, an operation that may be performed on an entity during an entity's lifecycle is defined, where the operation's definition specifies a characteristic of an entity property for that operation (i.e., whether a given property is editable, read-only, or the like). The characteristic, in turn, may determine whether an option, or the property itself, will be presented to a user in a UI. For example, a UI could present an editable property to a user while hiding a property that is read-only. Alternatively, the UI could display the read-only property with some indication that the property is read-only, or the like.

The lifecycle itself may then be defined in terms of the various operations that may take place during the lifecycle. The developer may therefore be able to write code to create a UI to access the entity's properties during the lifecycle based on the operations. It will be appreciated that because an embodiment keeps track of property characteristics within the operations themselves, the UI may be able to present appropriate properties to a user merely by preserving state information regarding where the entity is within its lifecycle. In other words, the UI does not need to account for the characteristics each property may have for a particular operation because the operation itself contains that information. The UI may only need to refer to the information contained in the operation to be able to present an appropriate property to a user.

As a result, an embodiment enables a developer to write relatively “generic” code to create a UI, and does not have to duplicate the logic that manages the operations that are performed on an entity, because the operations themselves contain information that enables such logic. In addition, the user experience is improved because the UI has a means by which unchangeable (i.e., read-only, locked, etc.) properties are not presented to the user as being editable.

Business software, for instance software involving workflow and orchestration technology may be used as a tool by which an entity's lifecycle is defined and managed in connection with a business process or the like. It will be appreciated that any such tool that is capable of defining and controlling an entity's lifecycle is compatible with an embodiment, and therefore the tools listed above are in no way an exhaustive list of tools that may be used in connection with an embodiment. Using any such tool, therefore, a developer or the like may define an entity lifecycle in terms of the operations that take place during such a lifecycle, and may define the operations themselves. It will be appreciated that by leveraging a business software tool's capabilities to manage an entity's lifecycle, the amount of code that might need to be written is minimized and simplified. In the discussion that follows, it is assumed that skilled in the art should be familiar with writing UI code and using business software or the like, and therefore details pertaining to such subjects are omitted herein for clarity. In addition, it should be appreciated that while examples may be described herein in connection with business software, embodiments of the invention are equally applicable to any field of endeavor and are not limited to such business applications.

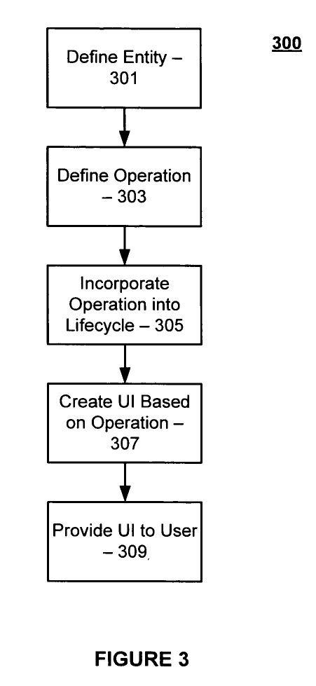

Referring now to FIG. 3, a flowchart illustrating an example method 300 of managing an entity lifecycle according to an embodiment of the invention is presented. At step 301 of method 300, an entity is defined. As noted above, a business software tool or the like may be used to define the entity. The entity may be any type of data entity such as, for example, a sales order or the like. It will be appreciated that the entity need not be used in connection with a business application. The entity, in an embodiment, has at least one property defined therein. For example, if the entity is a sales order, a property may be a customer name, address, item for sale, price and so forth.

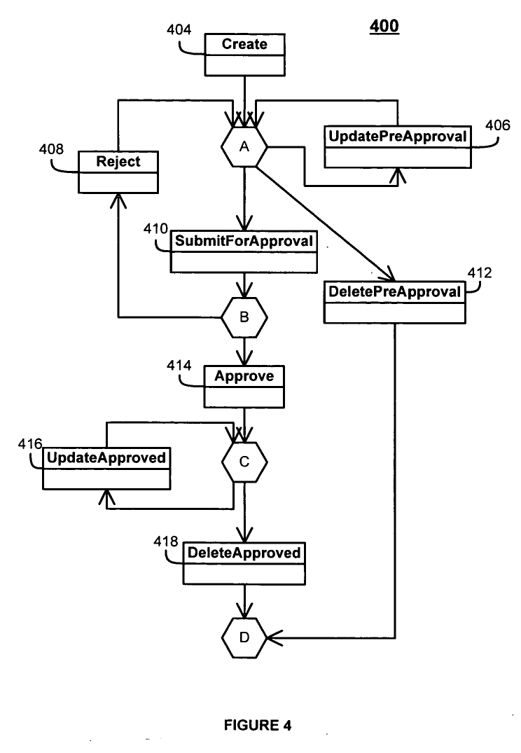

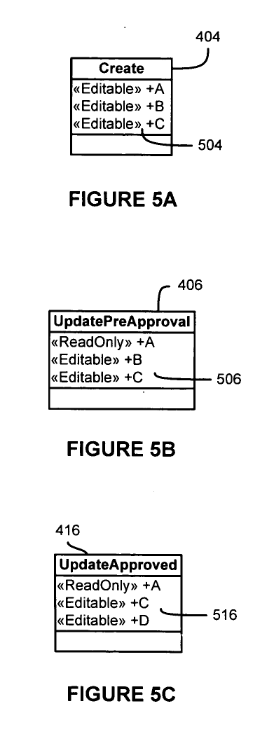

At step 303, an operation that may be performed on the entity during the entity's lifecycle is defined. Although it is not shown in FIG. 3 for clarity, an entity lifecycle may be optionally defined for planning purposes prior to step 303 so it will be known to a developer which operations should be defined in step 303. An example of such a preliminary lifecycle is discussed below in connection with FIG. 4. Regardless, the operation defined in step 303 may be any type of operation that is appropriate for the lifecycle. For example, the operation may involve creating an entity (if, for example, the operation is the first operation in the entity lifecycle), changing a property of the entity, approving the entity, deleting the entity and the like. The operation may also contain a listing of an entity property, and a characteristic each property has for that operation. For example, an entity may have two properties named “property1” and “property2,” where property1 is editable for the operation and property2 is read-only. Thus, an operation created in step 303 contains information that indicates that the entity has a property called property1 that is editable for this operation, and another property called property2 that is read-only. As a result, a UI that interacts with the operation—as will be discussed below—need only refer to the operation to determine which properties may be presented to a user as editable or as read-only, and does not need to maintain such information within the UI. Examples of operations that may be defined according to step 303 are discussed below in connection with FIGS. 5A-C.

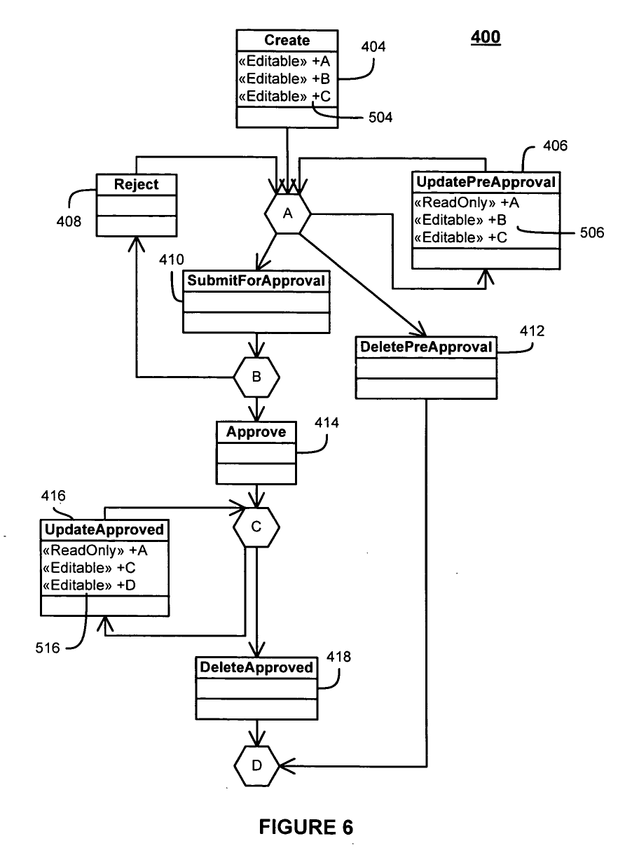

At step 305, the operation is incorporated into the lifecycle. Thus, at the completion of step 305, a completed lifecycle is defined, where the lifecycle has one or more defined operations that may take place on an entity. An example of such a completed lifecycle is discussed below in connection with FIG. 6.

At step 307, a UI is created based on an operation to be performed on the entity during the entity's lifecycle. As was noted above, a UI may be, for example, a form, query or the like that enables a user to interact with the entity. It should be appreciated that the term “user” as discussed herein is not limited to a human computer user, as the user of the UI may be another computer program or device, for example. Any type of UI may be created using any type of code such as, for example, a business software tool such as one described above. It will be appreciated that the code used to generate the UI need not contain the entity's property characteristics to determine whether to present a property to a user, or whether to enable a certain type of interaction with the property. This is because, as noted above in connection with step 303, an embodiment provides such information to the UI by way of the operation itself.

At step 309, the UI is presented to a user at appropriate points in the lifecycle, or continuously throughout the lifecycle, depending on the application of the UI. The UI may maintain state information or query the lifecycle tool to retrieve state information to determine where the entity is in its lifecycle. Once the UI determines which operation is currently taking place (or when another process informs the UI of such an operation), the UI accesses the operation to determine the type of operation to be performed, along with the properties that may be operated upon, according to each property's listed characteristic. Thus, the UI may present a property to a user if the property is editable or may refrain from presenting (or “hide”) a property that is not editable, according to the operation being performed. It will be appreciated that any number of display configurations may be implemented in connection with an embodiment. For example, a read-only property may be displayed to the user in a manner that indicates the property is not editable using, for example, a modified appearance such as shading, unique text or the like. Likewise, a property that is not editable may be effectively hidden from a user so as to provide a UI that is clear of unnecessary information.

Now that an example method of managing an entity lifecycle has been presented, an example implementation of such a method is illustrated in connection with FIGS. 4-6. In the example of FIGS. 4-6, an entity named EntityX is used for discussion purposes, and represents any type of entity that is used in connection with any field of endeavor, and is therefore not limited to a business application. EntityX, in the present example, has four properties: A, B, C and D.

Referring now to FIG. 4, an example lifecycle 400 for EntityX is illustrated. It will be appreciated that lifecycle 400 of FIG. 4 is merely illustrative, as an entity lifecycle according to an embodiment may take any form to accomplish any purpose. Operation 404 represents a Create operation to create EntityX. It should be appreciated that the names used in FIG. 4 to describe various operations (e.g., Create, SubmitForApproval, etc.), as well as the name EntityX, are merely illustrative, as any name in any naming convention may be used in connection with an embodiment. After creation of EntityX at operation 404, several different operations may take place with respect to EntityX in lifecycle 400. For example, EntityX may be submitted for approval at operation 410, may be deleted prior to approval by operation 412 or may be updated prior to approval by operation 406. The point in lifecycle 400 where operations 406, 410 and 412 may occur is graphically represented in FIG. 4 as point A. If EntityX is deleted by operation 412, lifecycle 400 ends at point D.

Once EntityX has been submitted for approval in operation 410, the approval may be either rejected by operation 408 or accepted (i.e., approved) by operation 414. The point in lifecycle 400 where operations 408 or 414 may occur is graphically represented in FIG. 4 as point B. If the approval is rejected by operation 408, the lifecycle is returned to point A, where operations 406, 410 and 412 may occur as discussed above. After EntityX has been approved by operation 414, at point C, EntityX may be updated by operation 416 or deleted by operation 418. If updated by operation 416, EntityX returns to point C where it can be updated again by operation 416 or deleted by operation 418 as discussed above. Once EntityX has been deleted, lifecycle 400 ends, as graphically represented by point D.

Now that an example lifecycle 400 has been described, various example operations that may take place within lifecycle 400 are now explained. As discussed above in connection with FIG. 3, lifecycle 400 may be defined before or after operations are created. In the present example, lifecycle 400 is created in preliminary form in FIG. 4, above, and then its operations are incorporated in FIG. 6, below. However, it will be appreciated that any methodology consistent with method 300 of FIG. 3 is consistent with at least one embodiment.

Referring now to FIG. 5A, therefore, the Create operation 404 is illustrated. Operation 404, as was discussed above in connection with FIG. 4, creates EntityX. Data 504 represents information contained within the Create operation 404 that indicates each property that is affected by operation 404, and a characteristic each property 504 has for operation 404. In FIG. 5A, it can be seen that properties A, B and C are all editable for operation 404, while property D is not involved in operation 404. Thus, it will be appreciated that in an embodiment a property such as property D may be added to an entity, such as EntityX, at any point in the entity's lifecycle.

Referring now to FIG. 5B, the UpdatePreApproval operation 406, as discussed above in connection with FIG. 4, is illustrated. Operation 406 also has data 506, which includes the relevant properties and their characteristics. It can be seen in FIG. 5B that property A is read-only, while properties B and C are editable. Again, property D is not involved in operation 406.

Turning now to FIG. 5C, the UpdateApproved operation 416, as discussed above in connection with FIG. 4, is illustrated. Operation 416 also has data 516, which again includes the relevant properties and their characteristics. It can be seen in FIG. 5C that property A is read-only, and properties C and D are editable. It can be seen that property B is not involved in operation 416.

It will be appreciated that in an embodiment not every operation in an entity's lifecycle needs to contain the data discussed above in connection with FIGS. 5A-C. For example, in the case of “reject” or “approve” operations, or the like, the properties of a data entity might not be modified during such a reject or approve operation. Thus, and as is illustrated in FIG. 6, not all operations have such data.

Referring now to FIG. 6, an example lifecycle 400 having operations that have been defined according to an embodiment is illustrated. It can be seen in FIG. 6 that lifecycle 400 is shown as discussed above in connection with FIG. 4. In addition, however, operations 404, 406 and 416 now include data 504, 506 and 516, respectively. Such data, as discussed above in connection with FIGS. 5A-C, describe each property that may be involved with the particular operation, and a characteristic that property has during such operation.

As a result, it will be appreciated that, according to an embodiment, a UI that presents such properties to a user does not need to independently verify which properties are involved in a particular operation, or which characteristic a property has for such an operation. Instead, an embodiment provides such information within the operation itself, thereby alleviating the need for incorporating such validation logic within the UI. As may be appreciated, this simplifies the task of creating multiple UIs (for example, in embodiments where multiple forms interact with the entity), because the UIs do not need to have this logic.

Likewise, a UI implemented according to an embodiment has a means by which to avoid presenting inappropriate properties to a user. For example, the UpdatePreApproval operation 406 indicates, in data 506, that property A is read-only. Thus, a UI reading such data 506 immediately is aware that property A should not be modified. Accordingly, a UI according to an embodiment need only contain logic that indicates the proper means by which to present (or not present) a read-only property, without having to hard-code the logic for every property in every operation. It will be appreciated that by having such logic that is enabled by the data contained within each operation, a user in one embodiment is not permitted to modify data that is read-only or otherwise not editable. Thus, a UI according to an embodiment need only maintain state information or query the lifecycle tool to retrieve state information sufficient to know where an entity is in its lifecycle, and the data contained within each operation enables the UI to present an entity's properties to a user in an appropriate manner.

While the present invention has been described in connection with the embodiments of the various figures, it is to be understood that other similar embodiments may be used or modifications and additions may be made to the described embodiment for performing the same function of the present invention without deviating therefrom. Therefore, the present invention should not be limited to any single embodiment, but rather should be construed in breadth and scope in accordance with the appended claims.

What is claimed:

1. A method of managing an entity lifecycle, comprising:
defining an entity having a property;
defining at least one operation having a property characteristic, wherein the operation may be performed on the property according to the characteristic;
creating the entity lifecycle having the at least one operation; and
rendering a user interface according to the at least one operation.

2. The method of claim 1, wherein the characteristic specifies whether the property is editable during the at least one operation.

3. The method of claim 2, wherein rendering the user interface comprises presenting the property in the user interface if the property is editable during the at least one operation.

4. The method of claim 2, wherein rendering the user interface comprises not presenting the property in the user interface if the property is not editable or read-only during the at least one operation.

5. The method of claim 1, wherein the property is a data field.

6. The method of claim 1, wherein the characteristic specifies whether the property is read-only during the at least one operation.

7. The method of claim 1, further comprising receiving a user input from the user interface and updating the property with the user input.

8. The method of claim 1, further comprising maintaining state information relating to the lifecycle.

9. The method of claim 8, wherein rendering the user interface takes place according to the state information.

10. A method for interacting with an entity, comprising:
defining a data entity having a first and second property;
defining an operation, wherein the operation specifies whether the first and second properties are editable;
creating an entity lifecycle having the at least one operation; and
rendering a user interface according to the at least one operation.

11. The method of claim 10, wherein rendering the user interface comprises presenting the first property in the user interface if the first property is editable.

12. The method of claim 10, wherein rendering the user interface further comprises not presenting the second property in the user interface if the second property is not editable or read-only.

13. The method of claim 10, wherein the operation is a first operation, and further comprising a second operation, wherein the second operation specifies whether the first and second properties are editable.

14. The method of claim 13, wherein defining the entity lifecycle comprises ordering the first and second operations within the lifecycle to permit interaction with the first and second properties to occur in a predefined order.

15. The method of claim 10, wherein rendering of the user interface further comprises maintaining state information relating to the lifecycle.

16. A computer-readable medium having stored thereon a data structure, comprising:
a first data field containing a data entity operation for interacting with a data entity property;
a second data field containing data identifying the data entity property; and
a third data field containing data representing a characteristic of the data entity property, wherein the characteristic indicates a type of interaction the data entity operation may have with the identified data entity property.

17. The computer-readable medium of claim 16, wherein the type of interaction indicated by the characteristic is whether the data entity property is editable.

18. The computer-readable medium of claim 16, wherein the type of interaction indicated by the characteristic is whether the data entity property is read-only.

19. The computer-readable medium of claim 18, wherein the characteristic provides a user interface with information relating to rendering of the data entity property.

20. The computer-readable medium of claim 16, wherein the data entity operation interacts with the data entity property during a data entity lifecycle.
